(19) United States
(12) Patent Application Publication
(10) Pub. No.: US 2009/0052962 A1
(43) Pub. Date: Feb. 26, 2009

(54) Extensible document system

(76) Inventor: Elizabeth Sloan Blauer, Sauk Rapids, MN (US)

Correspondence Address: Roger L. Belfay, 829 Tuscarora Avenue, Saint Paul, MN, 55102, US

(21) Appl. No.: 12/194,102

(22) Filed: Aug. 19, 2008

Related U.S. Application Data
(60) Provisional application No. 60/966,082, filed on Aug. 24, 2007.

(51) Int. Cl. G03G 15/00

(52) U.S. Cl. 399/361

(57) ABSTRACT

The extensible document system is a system for making documents, which can be increased in size by adding new sheets within the body of the document, comprising: a plurality of sheets, each sheet with at one or more coated edges, and one or more temporary fastening means to affix the sheets together to form a single larger sheet. The coating provided on the surface makes the surface resistant to deterioration when an adhesively attached object is detached.

The extensible document system is a system for making large documents by combining smaller ones and providing the appearance and function of a single large document.

### CROSS REFERENCE TO RELATED APPLICATIONS

There are no applications related to this application except as noted in the accompanying Application Data Sheet.

### STATEMENT REGARDING FEDERAL SPONSORSHIP

No invention claimed in this application was made under Federally sponsored research or development.

### BACKGROUND OF INVENTION

The creation and use of large documents has been a long sought goal of educators and publishers since at least the invention of the printing press. Many solutions to this problem have focused on the creation of large sheets which are then folded to facilitate binding and storage. The US utility patent to Lindsay (U.S. Pat. No. 7,094,195) is an invention which operates on this principal.

Another approach to the problem of large documents is to collect the parts into a collection. Examples of inventions raking this approach include: the US utility patent to Emmel et al (U.S. Pat. No. 5,683,194), and the US utility patent to Rose et al (U.S. Pat. No. 6,036,395).

The present invention provides a solution to this problem by providing a system which permits unlimited extension of a single document by adding sheets which give the appearance of a single large sheet. A further advantage of the present invention is the ability to evolve a large document by removing or adding selected sheets, in some cases from central positions.

### BRIEF SUMMARY OF THE INVENTION

The extensible document system is a system for making documents, which can be increased in size by adding new sheets within the body of the document, comprising: a plurality of sheets, each sheet with at one or more coated edges, and one or more temporary fastening means to affix the sheets together to form a single larger sheet. The coating provided on the surface makes the surface resistant to deterioration when an adhesively attached object is detached. In some embodiments the fastening means folds to permit the plurality of sheets to be folded into a stack forming a fan-folded stack.

### BRIEF DESCRIPTION OF THE DRAWINGS

FIG. 1 is a plan view of the Extensible Document System.

FIG. 2 is a perspective view of a tab.

FIG. 3 is an elevational edge view of a fan fold stack.

FIG. 4 is a perspective view of a sticker.

FIG. 5 is a perspective view of a flip up tab.

FIG. 6 is a perspective view of the invention, forming a fan folded stack.

FIG. 7 is a perspective view of the invention with flip up tabs, in use.

FIG. 8 is a perspective view of a plurality of sheets pair-wise attachable.

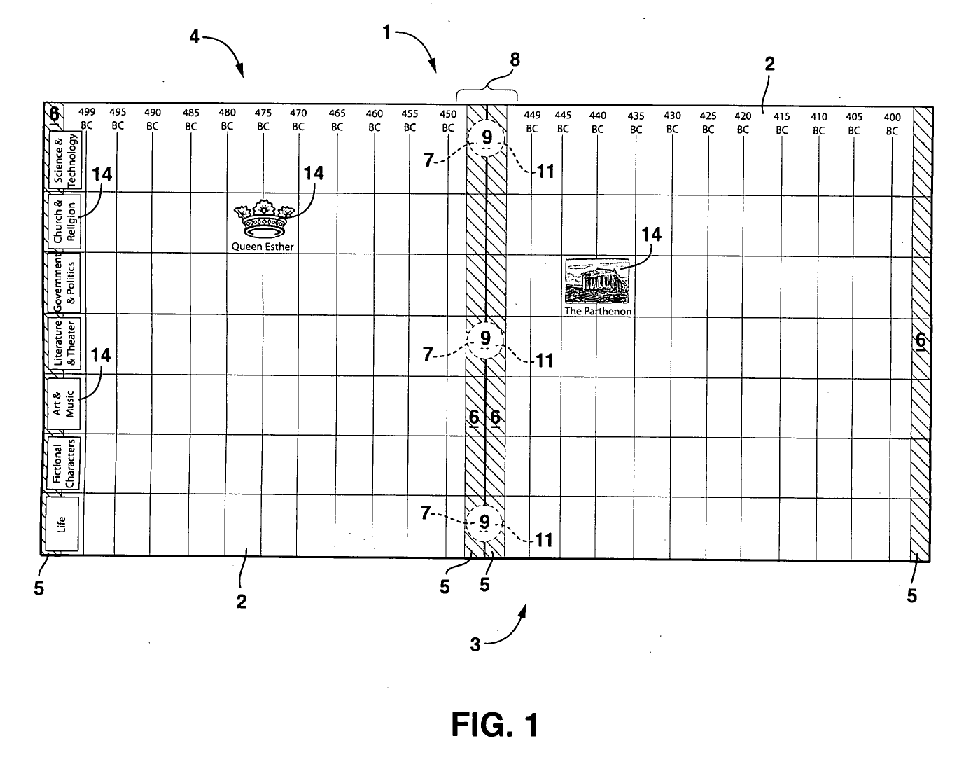

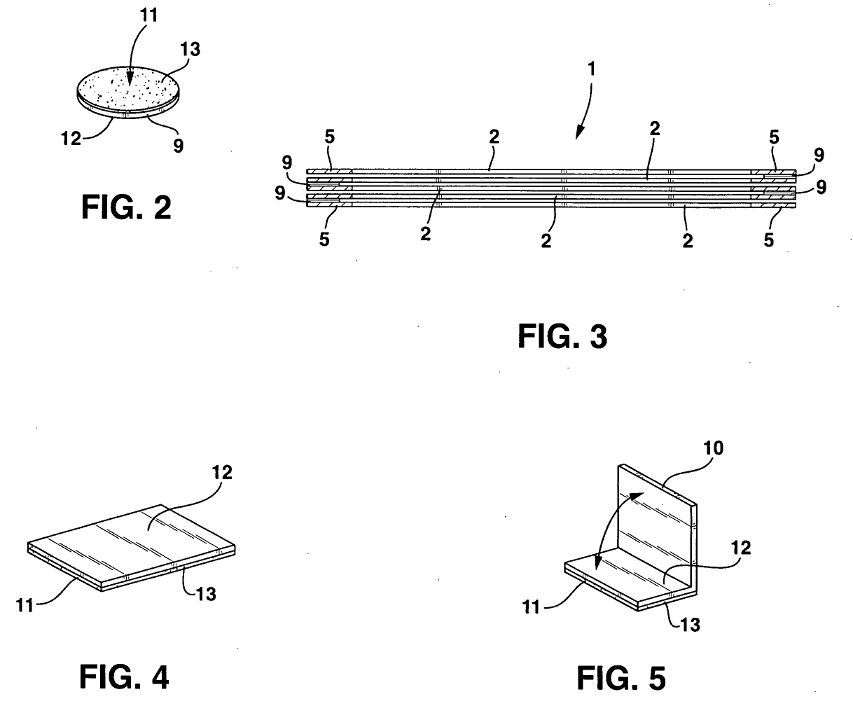

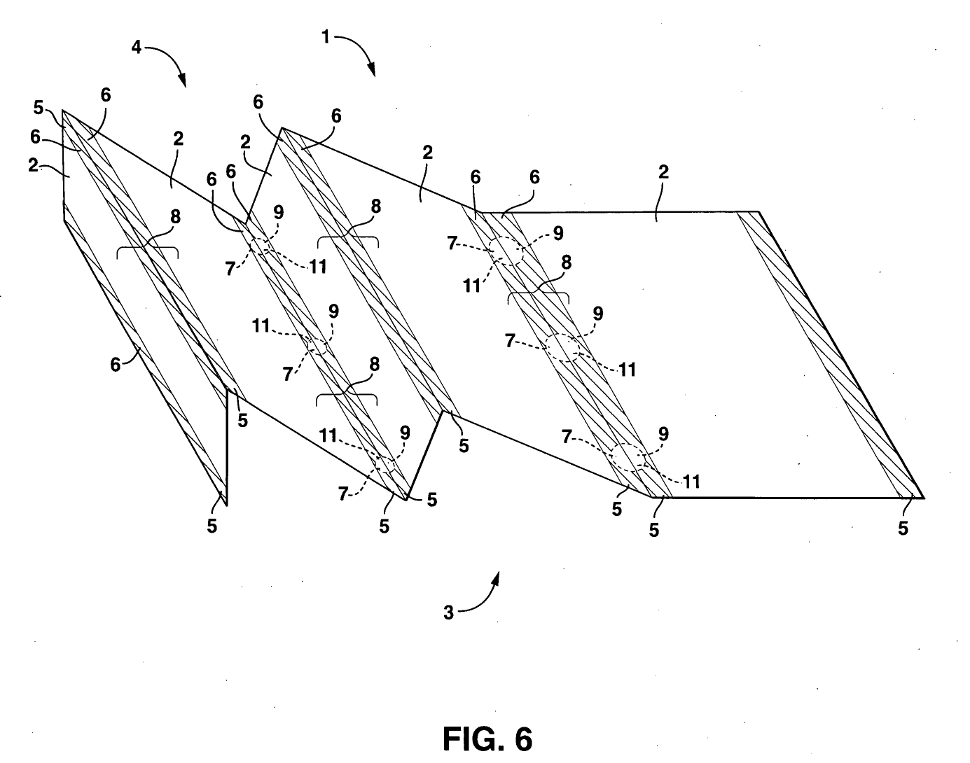

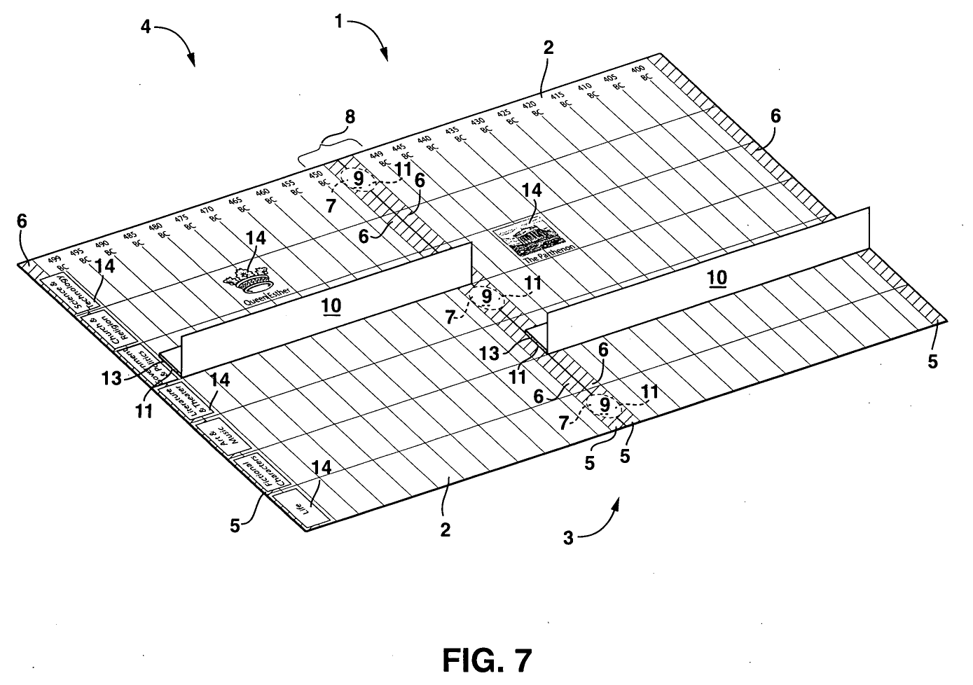

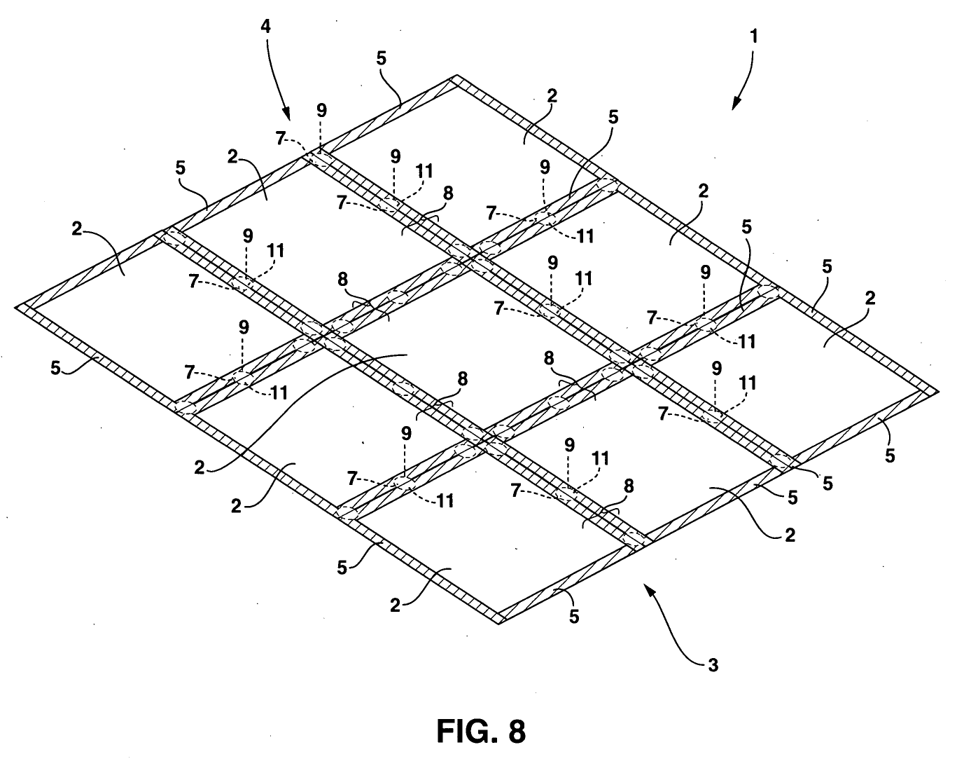

### DETAILED DESCRIPTION

The extensible document system 1 is a system for making documents 4 which can be increased in size by adding new sheets 2 within the body of the document 4 comprising: a plurality of sheets 2, each sheet 2 with at least one coated edge 5, said coating 6 provided on least one surface and resistant to deterioration when an adhesively attached object is detached; and a temporary fastening means 7 for adjacently pair-wise attaching 8 said plurality of sheets 2 to create the appearance and function of a single large sheet 3.

In some embodiments the fastening means 7 comprises one or more tabs 9, each of the tabs 9 comprising a layer of thin flexible material having a second surface 12 and a first surface 11, said first surface 11 provided with an adhesive coating. In some of these embodiments the fastening means 7 folds to permit the plurality of sheets 2 to be folded into a stack forming a fan-folded stack.

The extensible document system 1 may further comprise stickers 14 for placement anywhere on said sheets 2, said stickers 14 comprising at least one surface provided with an area coated with pressure sensitive adhesive.

The extensible document system 1 may include flip-up tabs 10, said flip up tabs 10 comprising at least one surface provided with an adhesive coating 13, said adhesive coating 13 applied to a portion of said surface to enable the uncoated portion of the flip-up tab 10 to be folded to reveal a portion of whatever is covered by the flip-up tab 10, including but not limited to: 1) a portion of a sheet 2, 2) a portion of another flip-up tab 10, or 3) a sticker 14. The flip-up tab 10 may be constructed entirely or in part of transparent material. It will be appreciated that the flip-up tab 10 may be unfolded to become flat and cover the underlying area or may be folded upon itself to cover a portion of said flip-up tab. Flip-up tabs 10 may be oriented in any way on the surface of the extensible document system.

It will be appreciated that the extensible document system 1's plurality of sheets 2 are pair-wise attachable 8 at two edges, but may include sheets 2 which may be pair-wise attachable 8 at one, three, or more edges.

The extensible document system 1 may also be implemented using sheets 2 which are attachable at all edges by reason of treatment of the entire sheet 2 for attachments.

I claim:

1) An extensible document system comprising:
a) a plurality of sheets, each sheet with at least one coated edge, said coating provided on least one surface and resistant to deterioration when an adhesively attached object is detached; and
b) a temporary fastening means for adjacently pair-wise attaching said plurality of sheets to create the appearance and function of a single large sheet.

2) The extensible document system of claim 1 wherein the fastening means comprises one or more tabs, each of the tabs comprising a layer of thin flexible material having a second surface and a first surface, said first surface provided with a coating of pressure sensitive adhesive.

3) The extensible document system of claim 2 wherein the fastening means folds to permit the plurality of sheets to be folded into a stack forming a fan-folded stack.

4) The extensible document system of claim 1 further comprising stickers for placement anywhere on said sheets, said stickers comprising at least one surface provided with an area coated with pressure sensitive adhesive.

5) The extensible document system of claim 1 further comprising flip-up tabs, said flip-up tabs comprising at least one surface provided with a coating of pressure sensitive adhesive, said coating applied to a portion of said surface to enable the uncoated portion of the flip-up tab to be folded to reveal a portion of the sheet covered by the flip-up tab.

6) The extensible document system of claim 1 wherein said plurality of sheets are pair-wise attachable at two edges.

7) The extensible document system of claim 6 wherein said plurality of sheets are pair-wise attachable at three or more edges.

10) An extensible document system comprising:
a) a plurality of sheets, each sheet with at least one tear resistant surface, said surface resistant to deterioration when an adhesively attached object is detached; and
b) a temporary fastening means for adjacently pair-wise attaching said plurality of sheets to create the appearance and function of a single large sheet.

11) The extensible document system of claim 10 wherein the fastening means comprises one or more tabs, each of the tabs comprising a layer of thin flexible material having a second surface and a first surface, said first surface provided with a coating of pressure sensitive adhesive.

12) The extensible document system of claim 11 wherein the fastening means folds to permit the plurality of sheets to be folded into a stack forming a fan-folded stack.

13) The extensible document system of claim 10 further comprising stickers for placement anywhere on said sheets, said stickers comprising at least one surface provided with a coating of pressure sensitive adhesive.

14) The extensible document system of claim 10 further comprising flip-up tabs, said flip-up tabs comprising at least one surface provided with a coating of pressure sensitive adhesive, said coating applied to a portion of said surface to enable the uncoated portion of the flip-up tab to be folded to reveal a portion of the sheet covered by the flip-up tab.

15) The extensible document system of claim 10 wherein said plurality of sheets are pair-wise attachable at two edges.

16) The extensible document system of claim 15 wherein said plurality of sheets are pair-wise attachable at three or more edges.
